(19) United States
(12) Patent Application Publication
(10) Pub. No.: US 2006/0013965 A1
(43) Pub. Date: Jan. 19, 2006

(54) Method of forming a coating on a plastic glazing

(76) Inventors: Alfred Hofrichter, Aachen (DE); Heinrich Kliem, Alsdorf (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/523,032

(22) PCT Filed: Aug. 4, 2003
(86) PCT No.: PCT/FR03/02458

§ 371 Date: Jul. 27, 2005

(30) Foreign Application Priority Data
Aug. 6, 2002 (FR) 02/10021

(51) Int. Cl. H05H 1/24

(52) U.S. Cl. 427/569; 427/585

(57) ABSTRACT

The present invention relates to a process for the formation of a coating on at least a portion of a plastic substrate, characterized in that it is carried out at a temperature at least equal to the maximum temperature of use of the coated substrate minus 20° C. The invention also relates to a product thus obtained with a minimum mean coating thickness of 2 μm and to the application of this product as vehicle body part, transportation vehicle window, window for the construction industry or street furniture, safety window or window which is resistant to heat.

The present invention relates to plastic windows.

Their significance is, for example, related to a search to render various types of vehicles lighter or to the production of complex shapes. Various transparent plastics can be employed, such as polycarbonate, poly(methyl methacrylate), polypropylene, polyurethane, poly(vinyl butyral), poly(ethylene glycol tere-phthalate), poly(butylene glycol terephthalate), ionomer resin, such as copolymer of ethylene and of (meth)acrylic acid neutralized by a polyamine, cyclo-olefin copolymer, such as ethylene/norbornene or ethylene/cyclopentadiene, polycarbonate/polyester copolymer, ethylene/vinyl acetate copolymer and the like, alone or as blends.

The relative scratchability of plastic substrates justifies the virtually general formation of scratch-resistant protective coatings in applications as windows, in particular. Coatings composed, for example, of carbon, hydrogen, silicon and oxygen can be formed according to any known process for the deposition of thin layers, in particular techniques for exothermic deposition, under vacuum, at relatively reduced pressure or atmospheric pressure; mention may be made, in this regard, of the following processes: PECVD (Plasma Enhanced Chemical Vapor Deposition), subsequently denoted by plasma CVD, electron beam evaporation, cathode sputtering magnetron, ion-assisted CVD, ion-source CVD, and the like.

These layers can comprise UV inhibitors and/or be combined with one or more other functional layers.

The inventors have observed the formation of particularly appreciable microcracking for layers possessing good resistance to abrasion and to scratching and all the more so when the window is used at high temperature, the ranges of use generally accepted for motor vehicles being from −30° C. to 90° C. or more broadly −40° C. to 100° C., and from −70° C. to 100° C. for aircraft. Moreover, Application EP 1 022 354 A2 discloses the heating of the plastic substrate prior to the formation of a layer by plasma CVD without even mentioning possible formation of cracks.

The inventors have now defined the criteria which make it possible to greatly slow down, or even eliminate, the formation of cracks, even when the plastic window is used at relatively high temperatures, of the order of 100° C., for example.

To this end, a subject matter of the invention is a process for the formation of a coating on at least a portion of a plastic substrate which is distinguished by the fact of being carried out at a temperature at least equal to the maximum temperature of use of the coated substrate minus 20° C. This temperature is that at which the substrate itself is stabilized from the beginning of the formation proper of the coating. Thus, the formation of microcracks itself is greatly slowed down, even when the coated substrate is used at high temperature, of the order of 100° C. and more, in particular.

In the context of the invention, the process favorably employs a plasma CVD. A coating based on silicon, oxygen, carbon and hydrogen, inter alia, and possessing adjustable properties is obtained from one or more pre-cursors, such as silane, hexamethyldisiloxane, tetra-methyldisiloxane, and the like. This technique also makes it possible to easily form stacks of layers. The operation is carried out at relatively reduced pressure or atmospheric pressure, with microwaves or radio frequencies.

Preferably, the process is carried out at a temperature at least equal to the maximum temperature of use of the coated substrate.

In addition, it is desirable, in the case of transparent substrates for which an optical quality is required, to carry out the process at a temperature below the temperature at which the plastic weakens. This term is understood to mean, for example, the softening temperature, melting point or phase transition temperature of the plastic, at which it begins to deform. Thus, when the substrate is made of polycarbonate, the formation of the coating is carried out at a temperature generally not exceeding 125° C., or up to 135° C. for specific grades.

In an advantageous implementation of the invention, the process is carried out at a temperature as close as possible to this temperature at which the plastic weakens.

Preferably, in particular when the deposition technique is exothermic, cooling means are employed in order to prevent the temperature at which the plastic weakens from being reached. This use is then particularly advantageous when, according to the above implementation, the operation is carried out as close as possible to this temperature at which weakening occurs. It may make it possible to have available the deposition time sufficient to obtain the required thicknesses, in several installments or indeed even only one.

With the aim of operating in the most favorable temperature ranges according to the invention, an advantageous embodiment consists in forming the coating in several stages. In particular, the process comprises the operations consisting successively in
a) stabilizing the substrate to be coated at a temperature at least equal to its maximum temperature of use minus 20° C.,
b) forming the coating while taking care that the temperature of the substrate does not reach the temperature at which the plastic weakens,
c) carrying out operations a) and b) again, if necessary, according to the thickness and other characteristics desired for the coating.

Although this is not a limitation of the invention, numerous processes envisaged in the context of the invention comprise exothermic deposition techniques in which the temperature of the substrate increases during the deposition of the coating; it may therefore be necessary, as already said, to interrupt the deposition in order to prevent the substrate from reaching the temperature at which its constituent material weakens and then to cool it to the minimum temperature required in accordance with the invention.

According to a particularly advantageous alternative form, the substrate is made of polycarbonate, the coating being formed at a temperature at least equal to 120° C.

Another subject matter of the invention is a product comprising a plastic substrate provided with a coating formed according to the process described above, the mean thickness of the coating being at least 2 μm, preferably at least 4 μm and particularly preferably at least 6 μm.

Another subject matter of the invention is the application of this product as plastic component which is not necessarily transparent, such as vehicle body part (door, fender, engine hood, vent or equivalent in applications other than motor vehicles) , as window, in particular for a ground, sea or air vehicle, in particular for a motor vehicle, a safety window for a helmet or a window of the type requiring resistance to heat. The application of a window of the invention for the construction industry or street furniture (billboard, bus shelter, and the like) is also advantageous.

The invention is illustrated by the following implementational example.

### EXAMPLE

A 300×850 mm polycarbonate sheet with a thickness of 4 mm sold by Bayer under the registered trademark Makrolon is subjected to the deposition of a coating by plasma CVD.

The deposition chamber is equipped with a 350×900 mm microwave plasma source composed of several individual microwave antennae operating in postdischarge mode with a total maximum power of 16 kW at a frequency of 2.45 GHz. The gases necessary for the deposition process (oxygen, argon and hexamethyldisiloxane) are introduced into the chamber through bulk flow control devices and metal pipes heated to 45° C.

In a first test in accordance with the invention, the coating is formed according to the following four stages:
1) heating the substrate to 120° C.;
2) depositing a coating with a thickness of 2.5 μm;
3) cooling the substrate to 120° C. by halting the deposition (exothermic); and
4) depositing a coating with a thickness of 2.5 μm.

The temperature reached by the substrate at the end of stages 2 and 4 is 124-1250° C., that is to say just below the softening temperature of the polycarbonate.

In a second test, the temperature of the substrate is not altered: a coating with a thickness of 5 μm is deposited in a single operation. The temperature of the substrate varies from approximately 20° C. (ambient temperature) to 85° C.

In a third test, the substrate is heated initially to 120° C. but a coating with a thickness of 5 μm is deposited “once only”. On conclusion of the formation of the layer, the substrate is at a temperature of 130-132° C., greater than the temperature at which the poly-carbonate weakens; its deformation renders it incompatible with an application as transparent product in which an even minimal optical quality is required.

The windows resulting from the first and second tests are subjected to 500 Taber cycle revolutions with a CS 10 F grinding wheel under a load of 500 g; the haze measured is less than 10% in both cases, which reflects a satisfactory resistance to abrasion.

Other windows resulting from the first and second tests are subjected to thermal cycling (ECER 43 10×−30° C. +90° C. in ten days), still others to storage at 90° C. and finally others to cooking in boiling water. The presence of cracks, respectively the moment at which they appear, is evaluated. The results are recorded in the table below.

TABLE

| | | Storage time | Cooking time |
|---|---|---|---|
| | | at 90° C. before | before the |
| | | the appearance | appearance |
| | Thermal | of the first | of the first |
| Test | cycling | cracks | cracks |
| 1 (according to | No | 8 days | 2 hours |
| the invention) | microcracking | | |
| 2 (without heating) | Microcracking | 15 min | 3 min |

The distances between the cracks observed in the coatings are of the order of 100 μm to 1 mm. Their appearance often precedes delamination of the coating.

The specific deposition process of the invention thus makes it possible to prevent or to slow down the appearance of microcracks; the beneficial consequences with regard to the adhesion of the coating to the substrate and with regard to the optical quality of the product are obvious.

1. A process for the formation of a coating on at least a portion of a plastic substrate, wherein said process is carried out at a temperature at least equal to the maximum temperature of use of the coated substrate minus 20° C.

2. The process as claimed in claim 1, wherein said process employs a plasma CVD.

3. The process as claimed in claim 1, wherein said process is carried out at a temperature at least equal to the maximum temperature of use of the coated substrate.

4. The process as claimed in claim 1, wherein said process is carried out at a temperature below the temperature at which the plastic weakens.

5. The process as claimed in claim 1, wherein said process is carried out at a temperature as close as possible to the temperature at which the plastic weakens.

6. The process as claimed in claim 1, wherein said process employs cooling means.

7. The process as claimed in claim 1, wherein said coating is formed in several stages.

8. The process as claimed in claim 1, wherein said process comprises the operations consisting successively in
a) stabilizing the substrate to be coated at a temperature at least equal to its maximum temperature of use minus 20° C.,
b) forming the coating while taking care that the temperature of the substrate does not reach the temperature at which the plastic weakens,
c) carrying out operations a) and b) again, if necessary, according to the thickness and other characteristics desired for the coating.

9. The process as claimed in claim 1, wherein the substrate comprises polycarbonate and wherein the process is carried out at a temperature at least equal to 120° C.

10. A product comprising a plastic substrate provided with a coating produced by the process as claimed in claim 1, wherein the mean thickness of the coating is at least 2 μm,

11. (canceled)

12. A vehicle body part, a vent, or a window comprising said product as claimed in claim 10.
